(19) United States
(12) Patent Application Publication
(10) Pub. No.: US 2014/0214620 A1
(43) Pub. Date: Jul. 31, 2014

(54) METHOD AND ARRANGEMENTS FOR ELECTRONIC SHELF LABELS

(71) Applicant: Pricer AB, Sollentuna (SE)

(72) Inventors: Nils Hulth, Uppsala (SE); Fredrik Tjerneld, Uppsala (SE)

(73) Assignee: PRICER AB, Sollentuna (SE)

(21) Appl. No.: 14/116,018

(22) PCT Filed: May 6, 2011
(86) PCT No.: PCT/SE2011/050573

§ 371 Date: Mar. 17, 2014

(51) Int. Cl. G06Q 30/06

(52) U.S. Cl. CPC G06Q 30/0623
USPC 705/26.61

(57) ABSTRACT

The present invention relates to a system and a method in a system that makes it possible for a service provider to provide product related information services to a mobile terminal in a store. The system comprises reading means in the mobile terminal configured to read a unique tag identity from an identity tag in an electronic shelf label, wherein the unique tag identity is different from a product id. Transmitting means in the mobile terminal is configured to transmit the unique tag identity from the mobile terminal to a tag identity server. Finding means in the tag identity server is configured to find in the tag identity server a meta data associated with the unique tag identity. In the tag identity server transmitting means is configured to transmit the meta data from the tag identity server to the mobile terminal. Displaying means in the mobile terminal configured to display the product related information services using the meta data.

### TECHNICAL FIELD

The present invention relates to a method and a system for enabling a service provider to provide product related information services to a mobile terminal in a store.

### BACKGROUND

ESLs, Electronic Shelf Labels, are generally electronic pricing and information labels that replace old paper labels, previously used in stores. Price and other information on the ESLs can be wirelessly changed from a computer. The price changes are done in the store's Price Controlling Application (PCA) system. The PCA contains a database which stores information about items in the store, e. g. product name, package size, and current price. The PCA system controls the actual price of an item and provides an ESL-system, to which the ESLs are connected, with updating information whenever the price is changed.

The ESL-system generally comprises software installed on an ESL-server, a hardware infrastructure and ESLs. The hardware infrastructure commonly comprises base stations, transceivers and cables. The ESLs are mounted with their items in the store, e.g. on the shelf-edges. Transceivers are normally mounted in the ceiling and base stations normally on a wall. A predetermined number of transceivers are connected to a base station, which is connected to the ESL-server. The ESL-server is connected to the PCA, often via the same network. There are also other types of ESL-systems which comprise fewer parts. One example is a system comprising only an ESL-server and a single transmitter or Access Point. The transmitter or Access Point may be wirelessly connected to the ESL-server.

Near Field Communication, NFC, is a type of short-range wireless communication technology. NFC involves an initiator and a target. The initiator actively generates an RF field that can power a passive target. This makes it possible for NFC targets to be very small e.g. tags and stickers that do not require batteries. NFC tags are today used in different payments solutions involving mobile phones. Most likely these payment solutions will be more widespread in the future than they are today when more mobile phones will involve NFC readers.

Other systems involving NFC in stores are systems where buyers can download product information using mobile phones supporting NFC. In these systems NFC-tags are associated with different products in the store. Many stores often change their product assortment and therefore have to change the NFC-tags or the information stored on the NFC-tags in order for NFC-tags to be up to date with the new product assortment. The alternative of putting NFC tags on each and every product is prohibitatively expensive.

There is therefore a need for an improved solution for providing product related information using NFC-tags in stores, a solution that solves or at least mitigates at least one of the above mentioned problems.

### SUMMARY

An object of the present invention is thus to provide methods and an arrangements for enabling a service provider to provide product related information services to a mobile terminal in a store.

According to a first aspect, the present invention relates to a system enabling a service provider to provide product related information services to a mobile terminal in a store, the system comprising: reading means in the mobile terminal configured to read a unique tag identity from an identity tag in an electronic shelf label, wherein the unique tag identity is different from a product id; transmitting means in the mobile terminal configured to transmit the unique tag identity from the mobile terminal to a tag identity server; finding means in the tag identity server configured to find in the tag identity server a meta data associated with the unique tag identity; transmitting means in the tag identity server configured to transmit the meta data from the tag identity server to the mobile terminal; displaying means in the mobile terminal configured to display the product related information services using the meta data.

Thus, the object is achieved according to the present invention by placing an identity tag comprising a unique tag identity that can be read using a mobile terminal in the ESL, wherein the unique tag identity is different from a product identity. In an ESL system the ESLs have electronic shelf label identities that identifies the different ESLs in the ESL system. Each ESL in the ESL system is then later associated with a product identity. This mapping between the ESL-identity and the product identity is performed by the store when they decide to use a specific ESL for a specific product. By also providing each ESL with the unique tag identity that is different from the product identity it is possible for the service provider to provide product related information services to the mobile terminal that requires involvement of the service provider. This is because it is only the service provider that has the metadata associated with the unique tag identity that is required to display the product related information services in the mobile terminal.

According to a second aspect, the present invention relates to a method in a system enabling a service provider to provide product related information services to a mobile terminal in a store. The method comprising the steps of: reading using a mobile terminal a unique tag identity from an identity tag in an electronic shelf label, wherein the unique tag identity is different from a product id; transmitting the unique tag identity from the mobile terminal to a tag identity server; finding in the tag identity server a meta data associated with the unique tag identity; transmitting the meta data from the tag identity server to the mobile terminal; displaying in the mobile terminal the product related information services using the meta data.

An advantage with embodiments of the present invention is that it is possible for the service provider to provide product related information services to the mobile terminal that requires involvement of the service provider. This is because it is only the service provider that has the metadata associated with the unique tag identity that is required to display the product related information services in the mobile terminal.

Yet another advantage with embodiments of the present invention wherein the unique tag identity is an NFC tag is that the product related information services can be provided to a lot of mobile terminals since NFC readers is implemented in many mobile terminals.

A further advantage with embodiments of the present invention is that it is possible to change the unique tag identity using the ESL-system.

### BRIEF DESCRIPTION OF THE DRAWINGS

The invention is described in more detail with reference to enclosed drawings, wherein:

FIG. 1 illustrates schematically a system according to an exemplary embodiment of the present invention.

FIG. 2 illustrates schematically a signaling diagram according to an exemplary embodiment of the present invention.

FIG. 3 illustrates schematically a system according to an exemplary embodiment of the present invention.

### DETAILED DESCRIPTION

In the following description, for purposes of explanation and not limitation, specific details are set forth, such as particular sequences of steps, signalling protocols and device configurations in order to provide a thorough understanding of the present invention. It will be apparent to one skilled in the art that the present invention may be carried out in other embodiments that depart from these specific details.

Moreover, those skilled in the art will appreciate that functions and means explained herein below may be implemented using software functioning in conjunction with a programmed microprocessor or general purpose computer, and/or using an application specific integrated circuit (ASIC). It will also be appreciated that while the current invention is primarily described in the form of methods and arrangements, the invention may also be embodied in a computer program product as well as a system comprising a computer processor and a memory coupled to the processor, wherein the memory is encoded with one or more programs that may perform the functions disclosed herein.

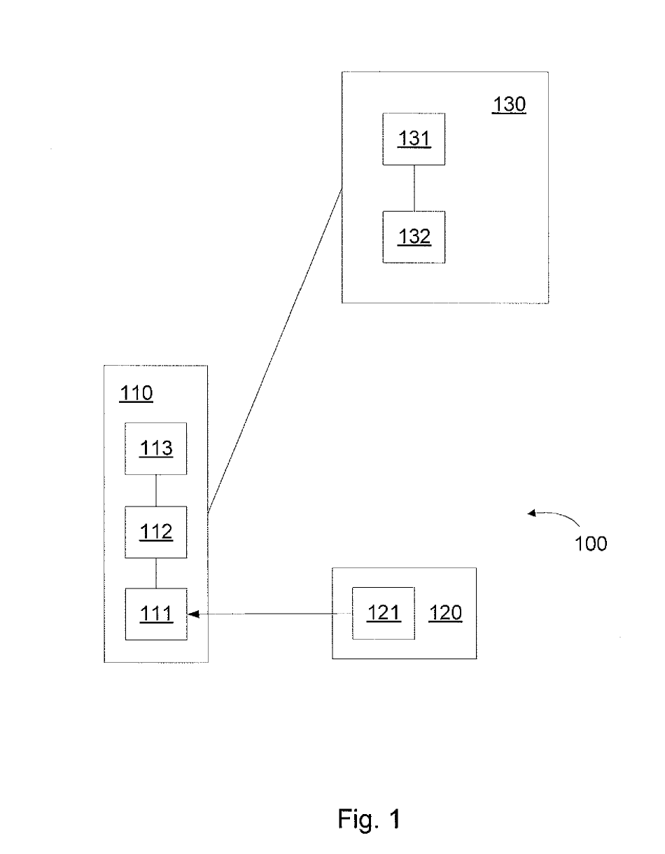

FIG. 1 shows a system 100 according to an exemplary embodiment of the present invention. The system 100 comprises a mobile terminal 110, an electronic shelf label 120 and a tag identity server 130. The mobile terminal 110 may be of any type having reading means 111 configured to read a unique tag identity from an identity tag 121 in the electronic shelf label 120. The unique tag identity is different from a product id. In an exemplary embodiment of the present invention the identity tag is a NFC-tag. The reading means 111 in the mobile terminal 110 may be of many different types e.g. an OCR-reader, but the reading means 111 is preferably configured for being able to read NFC-tags. The system 100 comprises at least one electronic shelf label 120. The electronic shelf label 120 may display price and other information about a product associated with the electronic shelf label 120. Furthermore the mobile terminal 110 comprises transmitting means 112 configured to transmit the unique tag identity from the mobile terminal 110 to a tag identity server 130. The tag identity server 130 is controlled by the service provider. In the tag identity server 130 there is finding means 131 configured to find in the tag identity server 130 a meta data associated with the unique tag identity. The meta data may be an electronic shelf label identity, a product identity, a URL or any combination thereof. In another exemplary embodiment the meta data may be a loyalty card, price or any other data related to the product. In the tag identity server 130 there is also transmitting means 132 configured to transmit the metadata from the tag identity server 130 to the mobile terminal 110. In an exemplary embodiment of the present invention the tag identity server 130 is operated in a secure mode by the service provider. This mode provides an increased security against the information being accessed by an unauthorized party. Further, in another exemplary embodiment of the present invention the tag identity server 130 is located at a site different from the store. This mode provides yet an increased security against the information being accessed by a unauthorized party. Using the metadata received from the transmitting means 132 a displaying means 113, in the mobile terminal 110, is configured to display the product related information services. In an exemplary embodiment where the metadata is a URL the displaying means 113 may transmit the URL to a server (not shown) storing the product related information. The server then uses the URL to find the product related information and transmits the product related information to the mobile terminal 110. The server may be operated and/or controlled by the store or by a manufacturer of the product or another provider. In yet another exemplary embodiment of the present invention, the metadata is the product identity or the electronic shelf label identity. In this exemplary embodiment the displaying means 113 may transmit the product identity or the electronic shelf label identity to a server (not shown) storing the product related information. The server then uses the product identity or the electronic shelf label identity to find the product related information and transmits the product related information to the mobile terminal 110. The server may be operated and/or controlled by the store or by a manufacturer of the product.

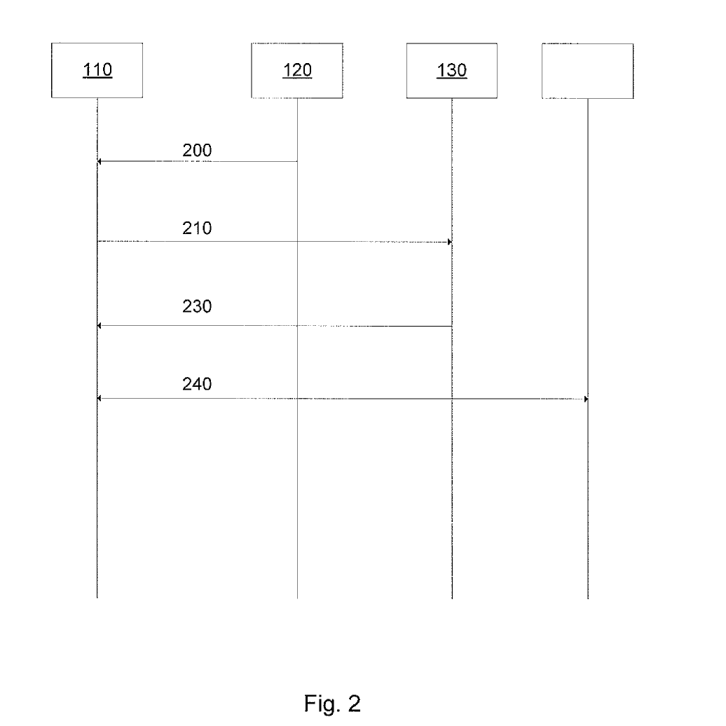

Referring to FIG. 2 there is illustrated a signalling diagram of a method to provide product related information services in accordance with previously described embodiments of the present invention. As shown in FIG. 2, the method comprises a first step 200 of reading using the mobile terminal 110 a unique tag identity from the identity tag 121 in the electronic shelf label 120, wherein the unique tag identity is different from a product id. In the next step 210 is the unique tag identity transmitted from the mobile terminal 110 to a tag identity server 130. Thereafter is the meta data associated with the unique tag identity found in step 220 (not shown) in the tag identity server 130. Next is the meta data transmitted in step 230 from the tag identity server 130 to the mobile terminal 110. The mobile terminal 110 then displays the product related information services using the meta data in step 240.

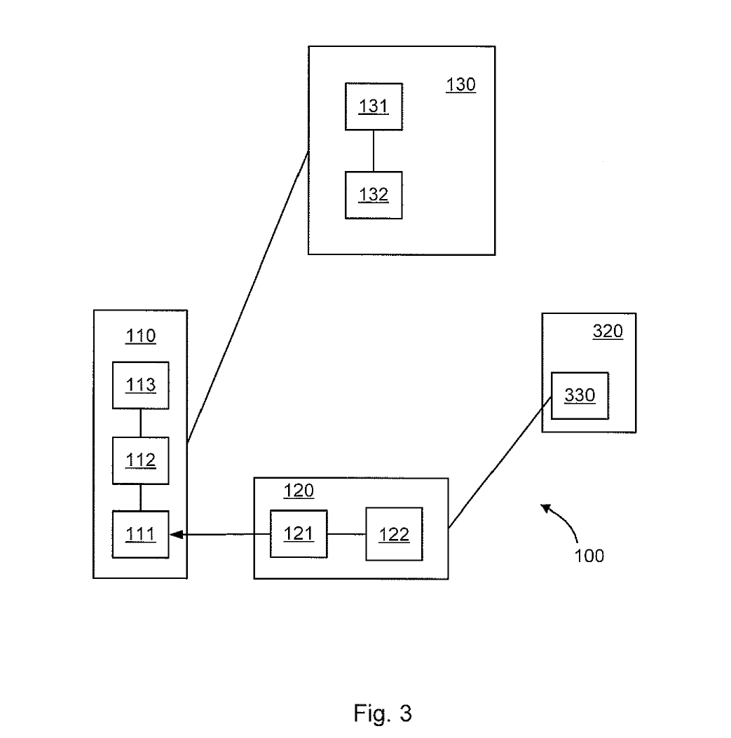

FIG. 3 shows another exemplary embodiment of the system 100 according to the present invention. In the embodiment can the unique tag identity in the identity tag 121 in the ESL 120 be updated with other information. In an ESL-server 320 in the store there is transmitting means 330 that transmits the information to the ESL 120. The ESL 120 further comprises updating means 122 configured to update the unique tag identity in the identity tag 121, with the information received from said ESL-server 320. In another exemplary embodiment of the system 100 a correct key has to be provided by the ESL-server 320 in order for the updating means 122 to update the unique tag identity with the information received from the ESL-server 320. The information can for instance be a URL or another unique tag identity or any combination thereof.

The present invention can be used with ESL-systems using Infrared communication, Radio communication or any other means of transmitting data from the ESL-system to the ESLs.

While the present invention has been described with respect to particular embodiments (including certain device arrangements and certain orders of steps within various methods), those skilled in the art will recognize that the present invention is not limited to the specific embodiments described and illustrated herein. Therefore, it is to be understood that this disclosure is only illustrative. Accordingly, it is intended that the invention be limited only by the scope of the claims appended hereto.

1. A method that allows a service provider to provide product related information services to a mobile terminal in a store, the method comprising the steps of:
reading, using a mobile terminal, a unique tag identity from an identity tag in an electronic shelf label (ESL), wherein said unique tag identity is different from a product id;
transmitting said unique tag identity from said mobile terminal to a tag identity server;
finding, by said tag identity server, meta data associated with said unique tag identity;
transmitting said meta data from said tag identity server to said mobile terminal;
displaying, in said mobile terminal, said product related information services using said meta data.

2. The method according to claim 1, wherein said unique tag identity is a near field communication (NFC) tag identity.

3. The method according to claim 1, wherein said tag identity server is operated in a secure mode by said service provider.

4. The method according to claim 1, wherein said meta data is an electronic shelf label identity, a product identity, a URL or any combination thereof.

5. The method according to claim 1, wherein said tag identity server is controlled by said service provider.

6. The method according to any of claim 1, wherein said tag identity server is located at a site different from said store.

7. A system that allows a service provider to provide product related information services to a mobile terminal in a store, the system comprising:
a mobile terminal, wherein the mobile terminal includes:
a reader configured to read a unique tag identity from an identity tag in an electronic shelf label, wherein said unique tag identity is different from a product id;
a transmitter configured to transmit said unique tag identity from said mobile terminal to a tag identity server; and
a display configured to display said product related information services based upon received meta data; and
a tag identity server, wherein the tag identity server is configured to find in said tag identity server meta data associated with said unique tag identity, wherein the tag identity server further includes:
a transmitter; configured to transmit said meta data from said tag identity server to said mobile terminal.

8. The system according to claim 7, wherein said identity tag is a near field communication (NFC) tag.

9. The system according to any of claim 7, wherein said tag identity server is operated in a secure mode by said service provider.

10. The system according to claim 7, wherein said meta data is an electronic shelf label identity, a product identity, a URL or any combination thereof.

11. The system according to any of claim 7, wherein said tag identity server is controlled by said service provider.

12. The system according to claim 7, wherein said tag identity server is located at a site different from said store.

13. The method according to claim 2, wherein said meta data is an electronic shelf label identity, a product identity, a URL or any combination thereof.

14. The method according to claim 2, wherein said tag identity server is controlled by said service provider.

15. The method according to claim 2, wherein said tag identity server is located at a site different from said store.

16. The method according to claim 3, wherein said meta data is an electronic shelf label identity, a product identity, a URL or any combination thereof.

17. The system according to claim 8, wherein said tag identity server is operated in a secure mode by said service provider.

18. The system according to claim 8, wherein said meta data is an electronic shelf label identity, a product identity, a URL or any combination thereof.

19. The system according to claim 8, wherein said tag identity server is controlled by said service provider.

20. The system according to claim 8, wherein said tag identity server is located at a site different from said store.
